(19) United States
(12) Patent Application Publication
(10) Pub. No.: US 2006/0214127 A1
(43) Pub. Date: Sep. 28, 2006

(54) Parallel plate valve assembly

(76) Inventors: Ali Shajii, Canton, MA (US); Jesse Ambrosina, Topsfield, MA (US); Leonard Myatt, Norfolk, MA (US); Matthew Mark Besen, Andover, MA (US)

Correspondence Address: MCDERMOTT WILL & EMERY LLP;ATTN: INTELLECTUAL PROPERTY DEPTARTMENT, 28 STATE STREET, BOSTON, MA, 02109, US

(21) Appl. No.: 11/089,681

(22) Filed: Mar. 25, 2005

(51) Int. Cl. F16K 31/44

(52) U.S. Cl. 251/279

(57) ABSTRACT

A valve assembly including a first plate having a first surface defining a port, a second plate received over the first plate such that the port of the first plate is substantially closed by a first surface of the second plate, wherein the second plate is movable away from the first plate to open the port, and a fixed member spaced from a second surface of the second plate, the second surface facing away from the first surface of the second plate. A first linkage has opposing first and second ends, and the first end is positioned adjacent the second surface of the second plate, and a second linkage has opposing first and second ends, and the first end is pivotally connected to the second end of the first linkage and the second end of the second linkage is positioned adjacent the fixed member.

### FIELD OF THE INVENTION

The present disclosure relates to the field of fluid flow control and, more particularly, to a valve assembly. Even more particularly, the present disclosure relates to a new and improved parallel plate-type valve assembly.

### BACKGROUND OF THE DISCLOSURE

Fluid valves exist in a wide variety of forms and sizes, serving a multitude of purposes, handling flowable materials whose characters range from light gaseous to heavy slurries and near-solids, and operable at various speeds under controls as diverse as simple binary (ON-OFF), proportional, direct-manual and remote-electrical. Those which are capable of responding quickly to govern even relatively large flows with precision, and with expenditure of little electrical power, are of special interest in certain industrial processing, such as the automatic regulation of gases in semiconductor and integrated-circuit manufacture. Mass flow controllers, for example, are widely used in semiconductor and integrated-circuit manufacturing to control the delivery of process gases, and the mass flow controllers include such valves.

U.S. Pat. No. 4,796,854 shows a proportional-control solenoid-actuated fluid valve, capable of governing relatively large volumes and rates of flow swiftly and accurately with expenditure of relatively little electrical power. The disclosed valve includes a movable valve member positioned by an armature having a substantially frictionless spring suspension, the armature being under influence of a special force-counterbalancer in the form of a bellows proportioned and disposed to exert upon it, automatically, neutralizing forces which are substantially equal and opposite to unavoidable pressure-induced imbalances afflicting the valve member. The same pressures which tend to unbalance the valve member are impressed upon opposite sides of the bellows, one through an enabling bleed port, and resulting forces developed by the bellows over a defined area are exerted upon the armature mechanically in a counterbalancing sense.

Other examples of more refined valve assemblies can be found in the Type 1479 and Type 1640 mass flow controllers available from MKS Instruments, Inc. of Andover, Mass. (http://www.mksinst.com).

These existing designs, accordingly, provide excellent proportional-control solenoid-type valves which can swiftly and accurately govern even relatively large volumes and high rates of fluid flow using relatively low levels of electrical power, since the valves are aided by the force counterbalancing achieved through the use of the bellows-type coupling. These existing valve assemblies also provide sensitive and precise valving by way of the frictionless suspension of broad-area valve members and the counterbalancing of undesirable pressure-generated forces through a correlated pressure-responsive coupling. One drawback of solenoid valves, however, is that they are relatively expensive, have a low range, and are sensitive to vibrations.

What is still desired is a new and improved valve assembly. The valve assembly will preferably provide all the benefits of previous valve assemblies, yet will be relatively inexpensive, have a higher range, and be relatively insensitive to vibration.

### SUMMARY OF THE DISCLOSURE

The present disclosure provides a valve assembly including a first plate having a first surface defining a port, and a second plate received over the first plate such that the port of the first plate is substantially closed by a first surface of the second plate, and wherein the second plate is movable away from the first plate to open the port. The second plate includes a second surface facing away from the first surface of the second plate, and a fixed member is spaced from the second surface of the second plate. The valve assembly also includes a first linkage having opposing first and second ends, and wherein the first end is positioned adjacent the second surface of the second plate. A second linkage has opposing first and second ends, and the first end is pivotally connected to the second end of the first linkage and the second end of the second linkage is positioned adjacent the fixed member.

Among other features and benefits, a valve assembly constructed in accordance with the present disclosure has been found to be relatively inexpensive, have a higher range, and be relatively insensitive to vibration. A valve assembly according to the present disclosure also provides all the benefits of prior existing valve assemblies, yet has a simple design, including fewer components that are easier to assembly together during manufacturing.

The advantage of this valve setup is that when the distance between the plates is small, the flow is controlled by frictional drop in the system. As the distance gets bigger, the flow is controlled by changing the effective flow-area provided by the system. This allows for the highly attractive feature of this setup, which is the wide range of operation. Note that, existing designs only rely on control of the effective flow-area in the valve setup, and this limits their use at much lower flow rates without changing for example the flow orifice. The main challenge in going to the parallel plate topology is the higher forces needed to control the distance between the plates.

These and other features and benefits of the present disclosure will become more apparent upon reading the following detailed description in combination with the accompanying drawings.

### BRIEF DESCRIPTION OF THE DRAWINGS

The foregoing and other features and advantages of this disclosure will be better understood from the detailed description and the drawings, in which:

FIG. 1 is a top perspective view of an exemplary embodiment of a valve assembly constructed in accordance with the present disclosure;

FIG. 2 is a section view of first and second parallel plates of the valve assembly of FIG. 1, shown in a closed position;

FIG. 3 is a section view of the first and the second parallel plates of the valve assembly of FIG. 1, shown in an opened position;

FIG. 4 is a section view of the first and the second parallel plates of the valve assembly of FIG. 1, shown in a further opened position;

FIG. 5 is a side elevation view, partially in section, of another exemplary embodiment of a valve assembly constructed in accordance with the present disclosure;

FIG. 6 is a top and end perspective view of a further exemplary embodiment of a valve assembly constructed in accordance with the present disclosure;

FIG. 7 is a graph of force required to open the valve of FIG. 6 versus amount of opening of the valve, for various fluid pressures;

FIG. 8 is a graph of flow rate through the valve of FIG. 6 versus amount of opening of the valve, for various fluid pressures;

FIG. 9 is a graph of actuator stroke versus amount of opening of the valve, for the valve of FIG. 6; and

FIG. 10 is a graph of actuator force versus amount of opening of the valve, for the valve of FIG. 6.

Like reference characters designate identical or corresponding components and units throughout the several views.

### DETAILED DESCRIPTION OF EXEMPLARY EMBODIMENTS

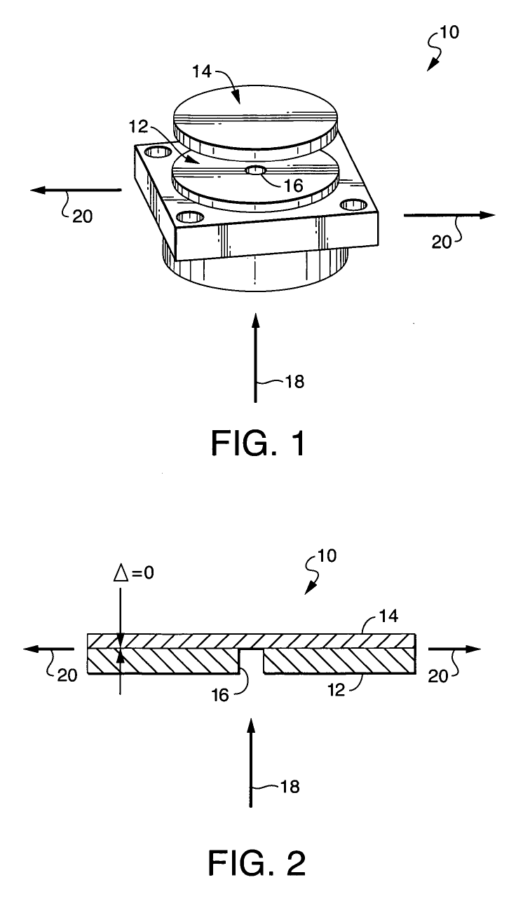

An exemplary embodiment of a valve assembly 10 constructed in accordance with the present disclosure is shown in FIGS. 1 through 4. The valve assembly 10 includes a first plate 12 defining a port 16, and a second plate received over the first plate 12 such that the port 16 of the first plate 12 can be substantially closed by the second plate, and the second plate 14 is movable away from the first plate 12 to open the port 16. At least one entering flow path 18 is connected to a first side of the first plate 12 and at least one exiting flow path 20 is connected to a second side of the first plate 12. Fluid is allowed to pass from the entering flow path 18, through the port 16 of the first plate 12, and into the exiting flow path 20 upon the second plate 14 being moved away from the first plate 12 to open the port 16.

The advantage of this valve setup is that when the distance between the plates is small, the flow is controlled by frictional drop in the system. As the distance gets bigger, the flow is controlled by changing the effective flow-area provided by the system. This allows for the highly attractive feature of this setup, which is the wide range of operation. Note that, existing designs only rely on control of the effective flow-area in the valve setup, and this limits their use at much lower flow rates without changing for example the flow orifice. The main challenge in going to the parallel plate topology is the higher forces needed to control the distance between the plates.

As shown, the first and the second plates 12, 14 are substantially parallel. In addition, the first and the second plates 12, 14 are both substantially flat, and both are provided with smooth contact surfaces. In one exemplary embodiment, the first and the second plates 12, 14 are made from a material suitable for handling semiconductor manufacturing process gases, such as stainless steel. In the exemplary embodiment shown, the first plate 12 is fixed in position and only the second plate 14 is movable. However, in other exemplary embodiments the first plate 12 can also be provided as being movable with respect to the second plate 14, such that both plates 12, 14 would move to open or close the port 16 of the first plate 12.

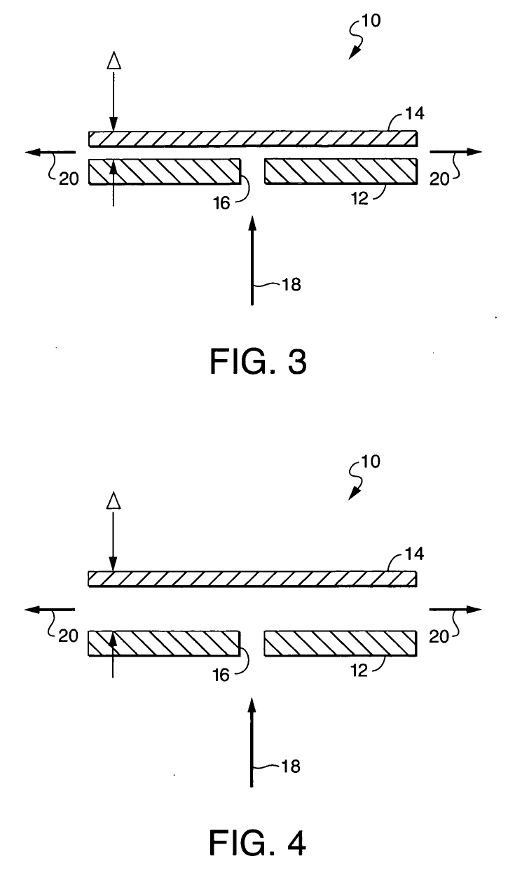

A vertical opening or distance “Δ” between the plates 12, 14 is shown in FIGS. 2 through 4. In FIG. 2, the distance Δ is equal to zero (0) so that the port 16 in the first plate 12 is closed. In FIG. 3, the distance Δ is greater than zero (0), such that the port 16 in the first plate 12 is opened and fluid flow is allowed through the port 16. In FIG. 4 the distance Δ is further increased so that fluid flow through the port 16 in the first plate 12 is further increased.

As an example of an application for the valve assembly 10 of FIGS. 1 through 4, the valve assembly 10 can be incorporated into a mass flow controller (MFC). As is known, a MFC is for controlling the flow rate of a gas from a source and can be used, for example, in the semiconductor manufacturing industry to precisely deliver a process vapor to a process chamber for making a semiconductor wafer. The MFC can be a temperature-based MFC or a pressure-based MFC, as well as other types of flow control devices. The MFC generally includes a flow path connected to the entering flow path 18 of the valve assembly 10, a flow sensor assembly for sensing flow through the flow path, and a control device programmed to receive a predetermined desired flow rate from a user, receive an indication of flow from the flow sensor assembly, and determine an actual flow rate through the flow path.

Although not shown in FIGS. 1 through 4, the valve assembly 10 also includes an actuator for moving the second plate 14 with respect to the first plate 12 to open and close the port 16 of the first plate 12. The actuator can comprise many types of actuators. For example, the actuator can comprise an electromechanical actuator such as a solenoid, a rotational motor or a voice coil actuator.

In one exemplary embodiment, the actuator comprises a voice coil actuator. Voice coil actuators are two wire non-commutated direct-drive, hysteresis-free, cog-free devices used for providing highly accurate linear and rotary motion. By virtue of their high acceleration and the absence of commutation, they offer numerous advantages in semi-conductor applications. For example, they deliver infinite position sensitivity, limited only by the encoder used for feedback., and a force-versus-stroke curve that is perfectly smooth. Voice coil actuators are ideal for short stroke (e.g., less than 0.02 inches) closed loop servo applications. Their compact size allows them to fit into small spaces, such as a flow controller. Voice coil actuators also have very low electrical and mechanical time constants, their low moving mass allows for high accelerations of light payloads. In addition, voice coil actuators are wound in such a way that no commutation is required for motion to occur, thereby providing a much simpler and more reliable system. Coupling the actuators with a bearing system, position feedback device, linear servo amplifier and motion controller yields a system that is capable of intricate position, velocity, and acceleration control. These actuators can also be used for precise force control because of the linear force versus current characteristics.

Regardless of the type of actuator used in the valve assembly, the control device of the flow controller is also programmed to instruct the actuator to move the second plate 14 away from the first plate 12, i.e., to increase flow, if the actual flow rate is less than the desired flow rate, and to move the second plate 14 towards the first plate 12, i.e., decrease flow, if the actual flow rate is greater than the desired flow rate. By “control device” it is meant herein a device or mechanism used to regulate or guide the operation of the MFC. The control device preferably comprises a computer processing unit (CPU) including at least a processor, memory and clock mounted on a circuit board. The control device operates in a feedback loop to maintain the desired flow at all times. Information on flow rate as a function of the valve assembly control current is preferably stored in the control device in order to quicken the response time of the MFC.

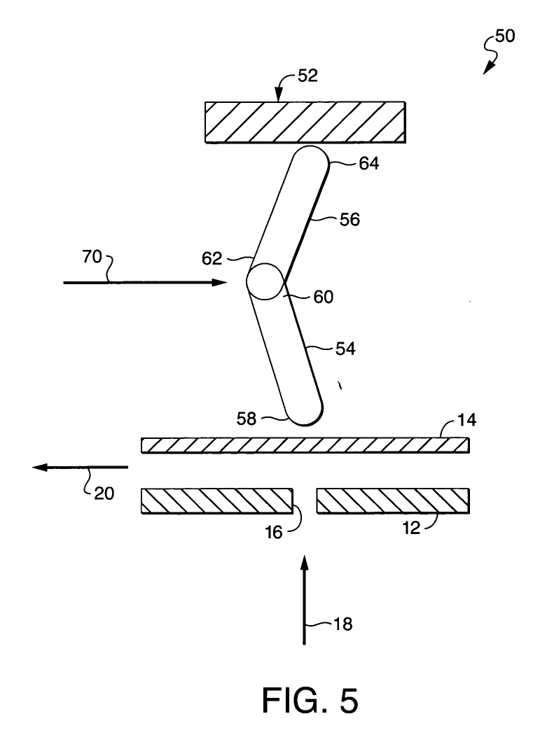

Another exemplary embodiment of a valve assembly 50 constructed in accordance with the present disclosure is shown in FIG. 5. The valve assembly 50 of FIG. 5 is similar to the valve assembly 10 of FIGS. 1 through 4, such that similar elements have the same reference characters. The valve assembly 50 of FIG. 5 also includes a fixed member 52 spaced from the second plate 14, a first linkage 54 having opposing first and second ends 58, 60, wherein the first end 58 is positioned adjacent the second plate 14, and a second linkage 56 having opposing first and second ends 62, 64, wherein the first end 62 is pivotally connected to the second end 60 of the first linkage 54 and the second end 64 of the second linkage 56 is positioned adjacent the fixed member 52.

During operation of the valve assembly 50, an actuating force 70 is applied to the first and the second linkages 54, 56 in order to cause the second plate 14 to move away from and towards the first plate 12 and control the rate of fluid flow through the port 16. In the exemplary embodiment of FIG. 5, for example, the force 70 is applied against the point of pivotal connection between the first end 62 of the second linkage 56 and the second end 60 of the first linkage 54. Varying the amount of force 70, in turn, varies the position of the second plate 14 with respect to the first plate 12. Although not shown, the valve assembly 50 of FIG. 5 also includes means for biasing the second plate 14 against the linkages 54, 56 and away from the first plate 12 or means for securing the second plate 14 to the linkages 54, 56, or both. For example, the first end 58 of the first linkage 54 can be pivotally connected to the second plate 14, so that applying the force 70 against (i.e., pushing) the linkages 54, 56 causes the second plate 14 to move towards the first plates 12, while applying the force 70 away from (i.e., pulling) the linkages 54, 56 causes the second plate 14 to move away the first plates 12. Alternatively, the valve assembly 50 can include a spring biasing the second plate 14 against the linkages 54, 56 so that simply reducing the force 70 against (i.e., pushing) the linkages 54, 56 allows the second plate 14 to be move away from the first plates 12 by the spring.

In the exemplary embodiment of FIG. 5, the first and the second linkages 54, 56 have substantially equal lengths. In addition, the first end 58 of the first linkage 54 and the second end 64 of the second linkage 56 are substantially aligned with the port 16 of the first plate 12.

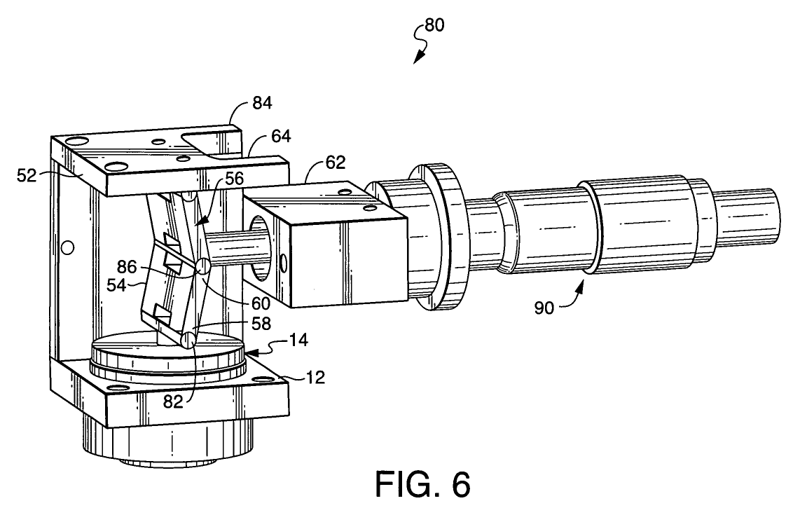

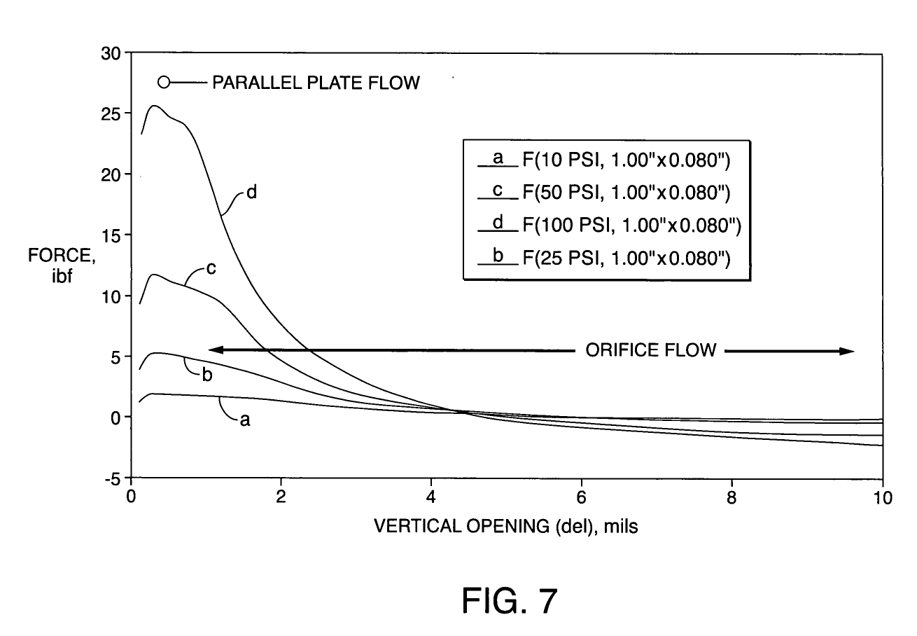

Another exemplary embodiment of a valve assembly 80 constructed in accordance with the present disclosure is shown in FIG. 6. The valve assembly 80 of FIG. 6 is similar to the valve assembly 50 of FIG. 5, such that similar elements have the same reference characters. In the exemplary embodiment of the valve assembly 80 of FIG. 6, the first end 58 of the first linkage 54 is pivotally connected to the second plate 14, and the second end 64 of the second linkage 56 is pivotally connected to the fixed member 52. In particular, the first end 58 of the first linkage 54 is pivotally coupled to the second plate 14 with a dowel pin 82 and the second end 64 of the second linkage 56 is pivotally coupled to the fixed member 52 with a dowel pin 84. In addition, the first and the second linkages 54, 56 are also pivotally coupled with a dowel pin 86. The valve assembly 80 is also shown with a micrometer 90 secured to the dowl pin 86 for purposes of testing, the results of which are shown in the graphs of FIGS. 7 through 10.

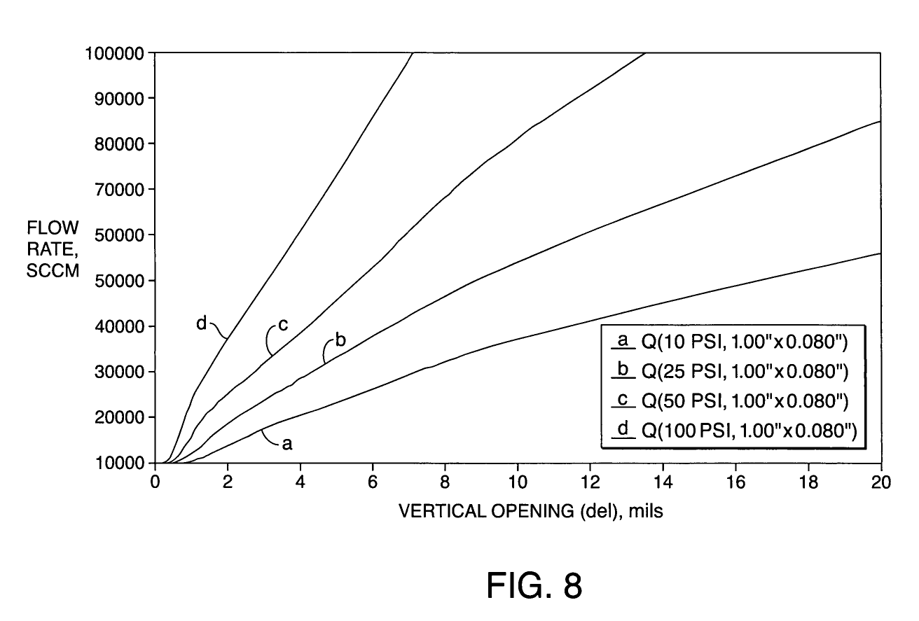

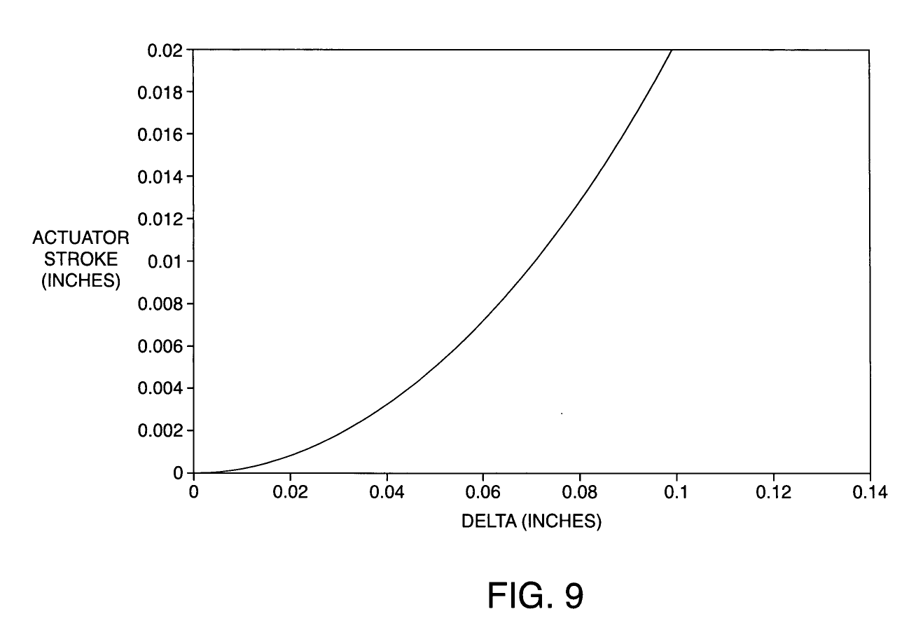

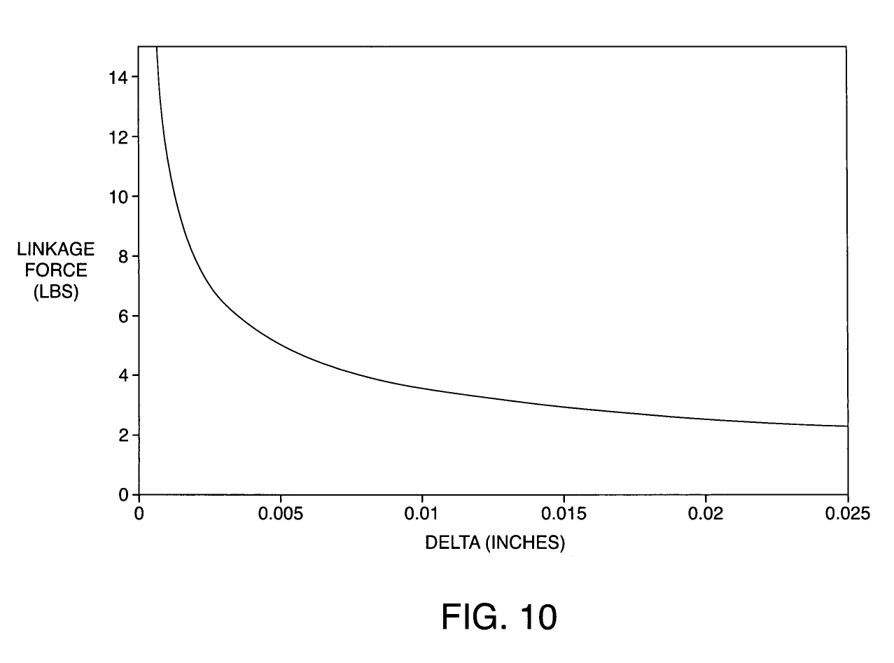

FIG. 7 is a graph of force required to open the valve of FIG. 6 versus an amount of opening of the valve, i.e., the distance Δ between the parallel plates 12, 14, for various fluid pressures a, b, c, and d. FIG. 8 is a graph of flow rate through the valve of FIG. 6 versus an amount of opening of the valve, i.e., the distance Δ between the parallel plates 12, 14, for various fluid pressures a, b, c, and d. FIG. 9 is a graph of actuator stroke versus amount of opening of the valve, i.e., the distance Δ between the parallel plates 12, 14, for the valve of FIG. 6. FIG. 10 is a graph of actuator force versus amount of opening of the valve, i.e., the distance Δ between the parallel plates 12, 14, for the valve of FIG. 6.

The embodiments and practices described in this specification have been presented by way of illustration rather than limitation, and various modifications, combinations and substitutions may be effected by those skilled in the art without departure either in spirit or scope from this disclosure in its broader aspects and as set forth in the appended claims.

1. A valve assembly comprising:
a first plate having a first surface defining a port;
a second plate received over the first plate such that the port of the first plate is substantially closed by a first surface of the second plate, wherein the second plate is movable away from the first plate to open the port;
a fixed member spaced from a second surface of the second plate, the second surface facing away from the first surface of the second plate;
a first linkage having opposing first and second ends, wherein the first end is positioned adjacent the second surface of the second plate; and
a second linkage having opposing first and second ends, wherein the first end is pivotally connected to the second end of the first linkage and the second end of the second linkage is positioned adjacent the fixed member.

2. A valve assembly according to claim 1, wherein the first plate is fixed in position with respect to the fixed member.

3. A valve assembly according to claim 1, wherein the first end of the first linkage is pivotally connected to the second plate.

4. A valve assembly according to claim 1, wherein the second end of the second linkage is pivotally connected to the fixed member.

5. A valve assembly according to claim 1, wherein the first and the second linkages have substantially equal lengths.

6. A valve assembly according to claim 1, further comprising an actuator connected to the second end of the first linkage.

7. A valve assembly according to claim 6, wherein the actuator is an electromechanical actuator.

8. A valve assembly according to claim 7, wherein the actuator is a voice coil actuator.

9. A flow controller including a valve assembly according to claim 1, and further comprising:
a flow path connected to port of the valve assembly; and
a flow sensor for sensing flow through the flow path.

10. A flow controller according to claim 9, further comprising an actuator connected to the second end of the first linkage.

11. A flow controller according to claim 10, further comprising a control device programmed to receive a desired flow rate from a user input device, receive an indication of flow from the flow sensor, determine an actual flow rate through the flow path, and actuate the actuator if one of the actual flow rate is less than the desired flow rate and the actual flow rate is greater than the desired flow rate.

12. A flow controller according to claim 11, wherein the control device is programmed to actuate the actuator if the actual flow rate is less than the desired flow rate.

13. A semiconductor manufacturing system including the flow controller of claim 9 and further comprising a source of process gas connected to a process chamber through the flow controller.

14. A flow controller according to claim 9, wherein the flow sensor is pressure based.

15. A flow controller according to claim 9, wherein the flow sensor is temperature based.

16. A valve assembly according to claim 1, wherein the first and the second plates are substantially parallel.

17. A valve assembly according to claim 1, wherein the first and the second plates are both substantially flat.

18. A valve assembly according to claim 1, wherein the first end of the first linkage and the second end of the second linkage are substantially aligned with the port of the first plate.

19. A valve assembly according to claim 1, wherein the first end of the first linkage is pivotally coupled to the second plate with a dowel pin and the second end of the second linkage is pivotally coupled to the fixed member with a dowel pin.

20. A valve assembly according to claim 1, wherein the first and the second linkages are pivotally coupled with a dowel pin.
